(19) United States
(12) Patent Application Publication
(10) Pub. No.: US 2010/0112508 A1
(43) Pub. Date: May 6, 2010

(54) REVERSIBLE AUTO-LINKED BRACKET OF LOW PROFILE WITH DOUBLE LOCK

(76) Inventor: ALEXANDRE GALLO LOPES, SERTAOZINHO SP (BR)

Correspondence Address: MCKEE, VOORHEES & SEASE, P.L.C., 801 GRAND AVENUE, SUITE 3200, DES MOINES, IA, 50309-2721, US

(21) Appl. No.: 12/477,529

(22) Filed: Jun. 3, 2009

(30) Foreign Application Priority Data
Nov. 3, 2008 (BR) MU8802474-1

(51) Int. Cl. A61C 7/28

(52) U.S. Cl. 433/10

(57) ABSTRACT

“REVERSIBLE AUTO-LINKED BRACKET OF LOW PROFILE WITH DOUBLE LOCK”, it consists of a bracket of single body with horizontal tube formed by two vertical fins with parallel channel, one in each fin, where is inserted the blade in the substantially “W” shape, whose shape combined with the manufacturing material propitiates memory so that enables the convertibility, and the body of bracket presents a superior lock and a inferior lock that keeps the blade opened for better handling of the traction elements (not represented), what becomes the bracket less augmented that summed with the rounded corners promotes a larger comfort and safety of collage.

### CROSS REFERENCE TO RELATED APPLICATIONS

This application claims priority from Brazilian Application MU8802474-1 filed Nov. 3, 2008, which is hereby incorporated by reference in its entirety.

### BACKGROUND OF THE INVENTION

The present patent of Utility Model request refers to a new “REVERSIBLE AUTO-LINKED BRACKET OF LOW PROFILE WITH DOUBLE LOCK”, especially of a bracket to be used in the dental treatment, susceptible to receive a stem or arch in specific tube properly closed and/or opened by sheet with spring effect, that when closed it cloisters the traction way, lodging in the superior lock, and when opened it anchors in inferior lock, facilitating the professional's work very much; it can also opt for the reversibility for a conventional bracket with the retreat of the sheet. On the other hand, the bracket presents an anatomical format of reduced volume and round corners, as well as the opening of the sheet always occurs from top to bottom, facilitating its handling, in that way supplying to the functional and operational needs of the treatment.

The brackets are the physical apparatuses of dental correction more used in orthodontia, could be manufactured of different metals and their alloys, plastics, composites and ceramics, standing out for its easiness of production, acceptance and biocompatibility.

In the current state of the technique there are two types of brackets. One of these types is the bracket of only fin, in that such fin extends from incisal to gingival or from oclusal to gingival with horizontal tube that extends from mesial to distal where it is positioned the thread, or threads, that exercise the necessary force of traction for the dental movement. The U.S. Pat. No. 6,190,166 anticipates a closure mechanism of tube composite by a clip grooved with closure in “V”, whose groove shapes in coincident groove located in the traction element.

Already the second kind of bracket is the one of double fins in which the body of bracket owns a fin in mesial and another in distal that are extended vertically from incisal to gingival or from oclusal to gingival with a horizontal rectangular tube from mesial to distal.

Along the dental treatment, the threads or arcs are inserted and removed from brackets several times as part of a normal procedure of treatment.

Some brackets, without the closure blade, has the thread linked or tied in order to avoid that it goes out from the tube, what jeopardizes the effectiveness of movement and/or hurts the patient. This model of lashing is laborious and consumes much time of the professional, having to be accomplished every time the thread or arc is changed.

Therefore, the auto-linked bracket solves the inconvenience of the conventional lashing of the threads and/or arcs, once that owns a closure and/or opening mechanism made possible by means of slide blade over the tube, thus facilitating excessively professional's work. Besides the time's gain, the auto-linked bracket promotes a connection and movement free of attrition because the blade provides a mechanic of sliding more efficient, once that lets the thread or arc free by the fact of introducing areas and points of minimum contacts.

The U.S. Patent Publication No. 2005/0239012 A1 anticipates a closure mechanism composite by a blade of rectangular shape, having an angulation whose locking in the body of bracket occurs on the median portion of such blade that hugs a cylindrical pin. Like the anchorage is punctual (just at the centre) the fixation of the tube is prejudiced.

Already the U.S. Patent Publication No. 2007/0259304 A1 anticipates a closure mechanism in which there is need to pressure a button to effect or liberate the closure blade.

Countless other patent documents anticipate closures means of the blades, each one with its positive and negative particularities, some of them related below.

The auto-linked bracket, for centralizing the force of movement and contact in the central area of tube, enables a larger inter-bracket distance, propitiating larger deflection of the thread or of the arc and consequent reduction of the forces exercised on the teeth; easiness of insertion and retreat of the traction elements.

Despite all the benefits, the auto-linked brackets present some inconvenient and technical limitations that in part bring some operational difficulties for the orthodontic professional.

In consonance with the paragraph above, auto-linked brackets well-known present only one element of superior lock that keeps the opening and/or closure blade in the closed position, in other words, over the tube that receives the traction element. However, the blade, when in the opened position, with the tube exposed, it is normal that the patient's perioral musculature closes the tube. With the tube outside the ideal position for handling of the traction element, partially or totally closed, it occurs a natural prejudice of the vision of the work field and consequent difficulty of handling, fact worsened by the dimensions of the components pertinent to the dental treatment.

Then, conventional brackets present their rectilinear corners what increase their volume and oblige the accomplishment of the treatment in two distinct stages, in other words, an arcade for time. Being this way, in the conventional auto-linked brackets, in the arcade inferior, the opening from bottom to top (to the oclusal or incisal of the teeth) increases consequently the profile of the bracket to accommodate the opening and/or closure mechanism, exactly in the region in which occlude the peaks and incisals of the superior teeth, what limits the placement of the pieces without before to treat the superior arcade, prolonging the time of treatment by the fact of not being possible to treat both the arcades.

Another inconvenience of the conventional auto-linked brackets is that the opening and/or closure blade does not present a mechanical memory so that enables its removal and replacement, because the loss of the spring effect, what limits the convertibility of the bracket from auto-linked to conventional and vice-versa, having the need of changing the bracket if perhaps occur this need during the treatment. This resource is necessary in the final stages of the treatment, when the stability of the treatment is critical, so that it can individualize the treatment expressing the particularities of twists, inclination and vestibule-lingual positioning of the teeth. In this phase, the use of metallic or elastomeric bondages is accomplished in the same way that in a conventional bracket, forcing the larger caliber arcs against the bottom of the horizontal tube, stabilizing the teeth in position (anchorage) and transforming the system in active to assist the demand of expressing twists, angulation, rotation and vestibule-lingual positioning inherent to the prescription of the bracket. With the combination of the passive systems, at the beginning of the treatment for the leveling and alignment, and active in the final stage of treatment, stability of the arcs and total expression of the prescription of brackets, the time of clinical treatment is significantly reduced.

### SUMMARY OF THE INVENTION

Aware of the inconvenient above mentioned, the inventor, acting person in the segment in valuation, has created the “REVERSIBLE AUTO-LINKED BRACKET OF LOW PROFILE WITH DOUBLE LOCK” at issue able to attend the needs of the dental treatment, which keeping the particularities of the brackets already used, of double fins, introduces the closure and/or opening blade with mechanical memory able to keep the spring effect, enabling several removals and replacements of said blade, attending perfectly the convertibility of the auto-linked bracket or conventional bracket for how many times how many are necessary. Like the conventional brackets just use the resiliencies of the material with which the blade is manufactured, the same lose mechanical memory due to the fatigue of the material.

The innovated bracket has besides the superior lock that is destined to keep bracket in the closed position, cloistering the traction element inside tube, also presents an inferior lock. This inferior lock enables that when the blade is in the opened position, it keeps the tube exposed, independent of the action of the patient's perioral musculature on the blade. This improvement is of great worth due to the size of the pieces and threads involved in the treatment, because the partial closure of the blade complicates the vision and the placement of the accessories.

Finally, the innovated bracket provides larger comfort to the patient due to its round corners and its low profile direct consequence of the trapezoidal format of the opening and/or closure mechanism, elapsing thus more efficiency of collage and comfort. The less augmented profile enables to the professional work both the arcades simultaneously, once that there is no space restriction for the placement of brackets. The opening direction of bracket is always from top to bottom, facilitating professional's performance.

### BRIEF DESCRIPTION OF THE DRAWINGS

To follow, the innovation will be explained with reference to the attached drawings, in which are represented of illustrative and not limiting way:

FIG. 1: View in exploded perspective of reversible auto-linked bracket of low profile with double lock;

FIG. 2: View in perspective of reversible auto-linked bracket of low profile with double lock, with the blade closed;

FIG. 3: View in perspective of reversible auto-linked bracket of low profile with double lock, with the blade opened and anchored in the inferior lock;

FIG. 4: Lateral view of reversible auto-linked bracket of low profile with double lock;

FIG. 5: Superior view of reversible auto-linked bracket of low profile with double lock;

FIG. 6: View in perspective of reversible auto-linked bracket of low profile with double lock, in a constructive variation.

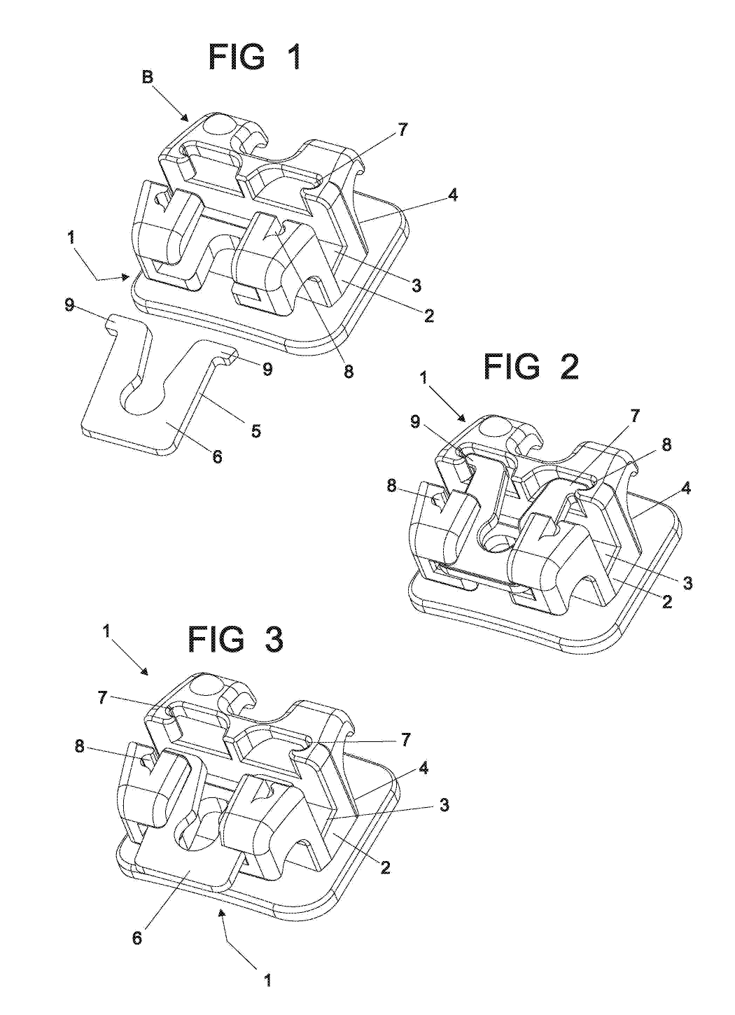

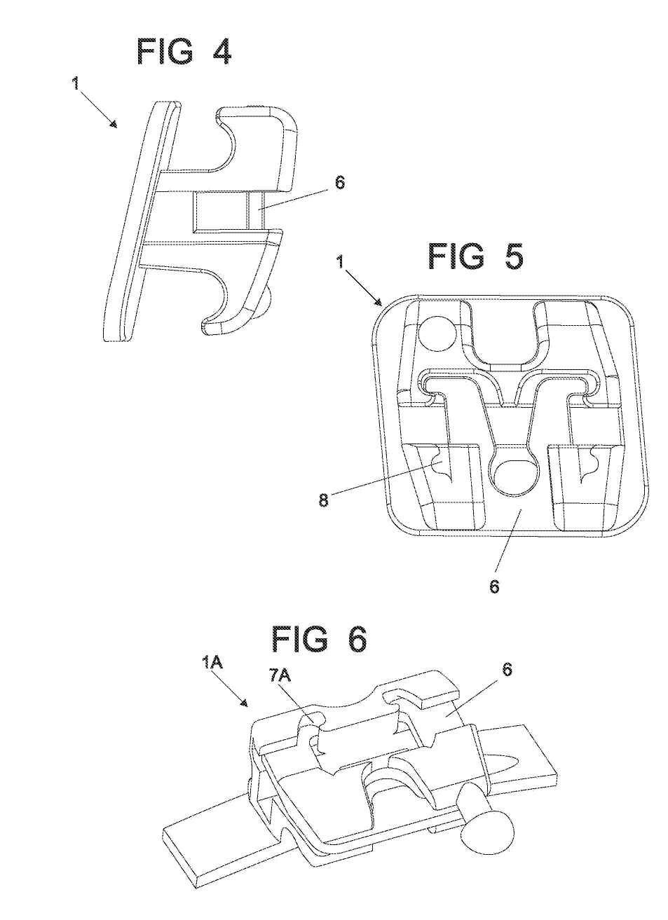

### DETAILED DESCRIPTION OF THE PREFERRED EMBODIMENT

“REVERSIBLE AUTO-LINKED BRACKET OF LOW PROFILE WITH DOUBLE LOCK”, object of this patent of Utility Model solicitation, consists of a bracket (1) of a single body (2) with horizontal tube (3) made by two vertical fins (4) with parallel channel, one in each fin (4), where is inserted the blade (6) in the format substantially in “W”, whose shape combined with the manufacturing material propitiates memory in order to enable the convertibility, and the body (2) of the bracket (1) introduces a superior lock (7) and an inferior lock (8) that keeps the blade (6) opened for better handling of the traction elements (not represented), what makes the bracket less augmented and summed with the rounded corners (B) promotes larger comfort and safety of collage. In a constructive variation, the bracket (1A) presents the blade (6A) closing in central locks (7A).

More particularly, the plead bracket (1) is formed by a single body (2) where a horizontal rectangular tube (3) and two vertical fins (4) are located, having parallel channels (5) through which ones the blade (6) of “W” shape, of nitinol or stainless steel, with mechanical memory, slip upwards in the closure sense, whose orthogonal extremities (9) engaging in the superior lock (7) of the body (2) of bracket (1), or downwards in the opening sense, attributing the convertibility particularity to the bracket (1) which without the blade (6) has the traction elements tied manually, and the blade (6) also can remain in an intermediary opening by the setting of the extremities (9) in the inferior lock (8), facilitating excessively professional's work, because it prevents the improper closure of the blade (6) by the patient's perioral muscle. For the removal of the blade (6), there is no need to special instruments, the professional can use the conventional instruments, because it is enough exercise a lever force besides the limit of locking of the blade (6) in the opened position and removal it, exposing totally the tube (3).

Therefore, the material with which the blade (6) is manufactured together with its “W” shape propitiates a spring effect during the opening and closure of tube (3) and its locking for several cycles. On the other hand, the closure mechanism contributes to become the bracket (1) less voluminous or more compact that together with the rounded corners (B) facilitates the placement of bracket (1) in confined areas, besides attributing more comfort to the patient. Then, the opening sense of the blade (6) occurs from top to bottom, to oclusal or incisal of the teeth, which also contributes for the reduction of volume of bracket (1). Such fact allows the simultaneous treatment of both the arcades.

In a constructive variation, the bracket (1A) is specific to be used in posterior molar teeth besides other teeth in the superior and inferior arcade, having a larger mesio-distal dimension, enabling the rotational control and control of engagement of the arcs completely, making the section of the arc used for dental movement in the three dimensions of the space be expressed faithfully due to the contact in the interface of the tube (slot)/arc in its total extension.

The opening and closure mechanism is similar to the first cited model, however the locking occurs of several ways since that the this bracket model (1A) has the channels (5A) of sliding of the blade (6A), occupying the extremities of the outside vertical fins (4A), and the lock (7A) located internally and centrally. Being this way, when the blade (6A) is in the closed position, its extremities (9 A) of locking remain protected by extensions in the locks (7A), avoiding the unlocking by the forces exercised by the arcs or by the chewing action.

What is claimed:

1. “REVERSIBLE AUTO-LINKED BRACKET OF LOW PROFILE WITH DOUBLE LOCK”, formed by
a single body where a horizontal rectangular tube and two vertical fins are located, having parallel channels;
wherein it receives the blade of “W” shape, of nitinol or stainless steel, with mechanical memory, which slips upwards or downwards once the orthogonal extremities engage in the superior lock of the body of bracket when of the closure, or downwards in the opening sense, attributing the convertibility particularity to bracket;
the blade can also remain in an intermediary opening by the setting of the extremities in the inferior lock;
the closure mechanism contributes to become the bracket more compact that together with the rounded corners facilitates the placement of the bracket in confined areas;
the opening sense of the blade occurs from top to bottom, to oclusal or incisal of the teeth, which also contributes for the reduction of volume of bracket.

2. “REVERSIBLE AUTO-LINKED BRACKET OF LOW PROFILE WITH DOUBLE LOCK”, according to claim 1 wherein, in a constructive variation, the bracket has the channels of sliding of the blade occupying the extremities of the outside vertical fins, and the lock located internally and centrally that receive the extremities of the blade.
